(19) United States
(12) Patent Application Publication
(10) Pub. No.: US 2004/0202880 A1
(43) Pub. Date: Oct. 14, 2004

(54) Method of plasma polymerisation of substituted benzenes, polymeric material obtainable by the method, and use thereof

(76) Inventors: Bjorn Winther-Jensen, Bronshoj (DK); Kimmie Arbjorn, Lyngby (DK)

Correspondence Address: JOHN S. PRATT, ESQ, KILPATRICK STOCKTON, LLP, 1100 PEACHTREE STREET, ATLANTA, GA, 30309, US

(21) Appl. No.: 10/478,949

(22) PCT Filed: May 23, 2002
(86) PCT No.: PCT/DK02/00354

(30) Foreign Application Priority Data
May 23, 2001 (EP) 01610053.9

(51) Int. Cl. C08F 2/46; B32B 27/00

(52) U.S. Cl. 428/500; 427/488

(57) ABSTRACT

A method of plasma polymerisation of monomers for providing a cross-linked polymeric material, the method comprising: treating a monomer gas in a plasma, said monomer gas comprising one or more monomers selected from substituted benzenes, wherein said plasma is generated by a multiple phase AC supply or a DC supply at a plasma power density allowing a substantial portion of substituent groups of said substituted benzenes to be preserved.

### DESCRIPTION

The present invention relates to a method of plasma polymerisation of monomers, in particular substituted benzenes, for providing a cross-linked polymeric material, a polymeric material obtainable by the method, a coated substrate coated with such polymeric material, and use of such polymeric material or coated substrate, e.g. for immobilisation of chemical substances, in particular bio-molecules.

### THE TECHNICAL FIELD

Generally, immobilisation of biomolecules on substrates is achieved by reacting functional groups of the bio-molecules to chemically reactive groups of the substrate.

Chemically reactive groups of the substrate comprise functional groups of the substrate material itself and functional groups of substances attached or bonded to the substrate material by suitable bonding. Bonding include e.g. covalent, ionic, or affinity bonding either directly to the substrate or indirectly to the substrate through spacers and intermediate layers of coatings such as base coating and intermediate coating.

Generally, functional groups of the substrate are located at the surface of the substrate material, however, the nature of the surface may include inner surfaces of the substrate material, e.g. for folded or porous surfaces.

Chemically reactive groups of the substrate comprises chemical groups such as amine —NH₂, thiol —SH, hydroxyl —OH, epoxy —HC—O—CH—, aldehyde —CHO, carboxylic acid —COOH, acidic anhydride —CH₂CO—O—COCH₂—, and carbonyl chloride —COCl, which are fixed to the substrate material either directly or indirectly through spacers and intermediate compounds.

Bonding of these chemically reactive groups to the substrate involves use of substances which are very reactive and which can be polymerised in plasma.

Generally such reactive substances contain one polymerisable group, e.g., an acrylic or a vinyl group and the chemically reactive group. During the plasma polymerisation the polymerisable group reacts whereby the polymer material is formed. The degree of cross-linking of such a polymer material formed by plasma polymerisation of reactive substances comprising one polymerisable group is not well understood and can be difficult to control.

Consequently, there is a need for a method of providing chemically reactive groups on a substrate whereby these prior art disadvantages are avoided.

Furthermore the present invention enables fabrication of polymer materials with well-controlled cross-link density and well-controlled reactive group density.

Generally, a prior art plasma deposition apparatus comprise two or more electrodes connected to a power supply, both of alternating current or direct current types, said electrodes being adapted to generate a plasma by electrical glow discharge in a gas introduced between them.

In such plasma, however, the gas is subjected to plasma of high energy, providing a high degree of decomposition of the excited gas. Further, such high energetic plasma is often inhomogeneously distributed, resulting in an inhomogeneous distribution of the excited gas.

### PRIOR ART DISCLOSURES

EP 0 741 404 B1 discloses a method and an electrode system for excitation of a plasma.

WO 00/44207 discloses a method of excitation of plasma by means of a plurality of electrode systems.

U.S. Pat. No. 6,020,458 discloses a method for the synthesis of low dielectric constant materials with improved thermal stability based on plasma polymerisation of fluorinated aromatic precursors in a post plasma process, said plasma being generated by a radiofrequency (RF) plasma generator operating at 13.56 MHz at a power of 30 W to 300 W. Also an inductively coupled RF plasma apparatus is employed which is operated at 13.56 MHz at power of 100 W to 4000 W. The polymer material obtained by these methods have a high degree of sp²C=sp²C bonds.

WO 95/04609 discloses a method for coating a polymer substrate with a hydrophilic film, based on plasma deposition of an organic compound, such as a substituted benzene, in a hydrogen peroxide plasma jet, generated by a microwave plasma source operating at 2.45 GHz at a power of 240 to 600 W. Also a 40 kHz alternating current plasma apparatus and a direct current plasma apparatus are employed at a power of 5 W.

U.S. Pat. No. 4,649,071 discloses a method for the synthesis of a composite material based on plasma polymerisation of organic compounds, such as a substituted benzenes, in an RF plasma apparatus operated at 13.56 MHz at a power of 100 W.

### DISCLOSURE OF THE INVENTION

Object of the Invention

It is an object of the present invention to seek to provide a method of preparing a substrate with chemical reactive groups.

It is an object of the present invention to seek to provide a method for the synthesis of chemically reactive polymer material with a high cross-link density.

It is an object of the present invention to seek to provide a method for the synthesis of chemically reactive polymer material with well-controlled cross-link density.

Further objects appear from the description elsewhere.

Solution According to the Invention

According to the present invention, these objects are fulfilled by providing a method of plasma polymerisation of monomers for providing a cross-linked polymeric material, the method comprising: treating a monomer gas in a plasma, said monomer gas comprising one or more monomers selected from substituted benzenes, wherein said plasma is generated by a multiple phase AC supply or a DC supply at a plasma power density allowing a substantial portion of substituent groups of said substituted benzenes to be preserved.

It has surprisingly turned out that for plasma generated by a multiple phase AC supply or a DC supply the level intensity can be adjusted so that a substantial portion of the substituent groups (chemical reactive groups) of the substituted benzenes can be preserved, and so that a substantial portion of the aromatic double bonds are reacted thereby forming a polymeric material.

One very interesting observation is that the number of double bonds originating from the benzene structure is reduced dramatically or are virtually absent in the polymeric material and at the same time a substantial amount of functional groups of the substituted benzens is present in the polymeric material.

The advantage of using a substituted benzene ring as the polymerisable group rather than a mono-functional polymerisable group, such as vinyl or acrylate, is the fact that the benzene ring can react as a mono-, di-, or tri-functional polymerisable group.

For the present method, the higher the plasma power density which still ensures that a substantial portion of the substituent groups are preserved during the plasma polymerisation, the higher the functionality of the benzene ring.

A further advantage of using substituted benzenes over mono-functional polymerisable groups is the fact that the reactivity of the benzene ring is not very sensitive to the degree of substitution. This is in contrast to vinyl and acrylate whose reactivities as polymerisable groups are both very sensitive to substitution.

When used herein, the term “polymeric material” is intended to mean a material prepared from a mixture of discrete low molecular weight compounds. Whether such low molecular weight compounds (“monomers”) include groups which are considered as polymerisable in the normal sense, e.g. vinyl groups, is irrelevant for the purpose of the definition. Rather, the compounds used as “monomers” will—due to the presence of substituted benzenes form a highly cross-linked structure under the plasma polymerisation conditions in that the aromatic double bonds of the benzene system apparently undergo some kind of polymerisation via radical generation. The monomers will most often also form strong covalent bonds with the substrate, e.g. Si—C—R bonds with Si—H groups of a hydrogen-treated silicon substrate (See the examples, e.g. Example 1).

Preferred Embodiments

The term “monomer” is intended to mean a low molecular weight species. Most often, the monomers have a molecular weight of at the most of 450. Preferred monomers are those having a molecular weight of at the most 200.

The plasma polymerisation is effected with a monomer gas comprising one or more types of monomers selected from substituted benzenes. The substituted benzenes may—as a matter of definition—have 1-6 substituents, but will most often have 1-4 substituents, preferably 2-4 substituents, in particular 2-3 substituents. It is believed that preferred substituted benzenes are those having at least two substituents.

Generally, substituted benzens can have any suitable substituent ensuring the desired polymerisation of the benzene ring.

In an embodiment, substituted benzenes may have no conventionally polymerisable substituent groups such as alkenyl, alkynyl, etc.

Examples of suitable substituted benzene monomers have the general formula:

Ar(Rⁿ)ₙ

wherein Ar is a benzene ring, n is 1-6 and Rⁿ is n substituents (R¹, R², R³, R⁴, R⁵, R⁶) covalently bound to the benzene ring, the substituents (R¹, R², R³, R⁴, R⁵, R⁶) being independently selected from C₁₋₆-alkyl, C₁₋₆-alkoxy, C₁₋₆-alkylcarbonyl, C₁₋₆-alkylcarbonyl, C₁₋₆-alkoxycarbonyl, carbamoyl, mono- and di(C₁₋₆-alkyl)aminocarbonyl, formyl, hydroxy, carboxy, carbamido, thiolo, nitro, cyano, nitro, amino, mono- and di(C₁₋₆-alkyl)amino, and halogen (fluoro, chloro, iodo, bromo), wherein the C₁₋₆-alkyl and C₁₋₆-alkoxy groups in the above may be substituted with substituents, preferably 1-3 substituents, selected from hydroxy, C₁₋₆-alkoxy, carboxy, amino, mono- and di(C₁₋₆-alkyl)amino and halogen.

In the formula above, it is preferred that the substituents are selected from C₁₋₂-alkyl, amino, and halogen.

Particular examples of suitable substituted benzenes are p-xylene, m-xylene, o-xylene, o-methylaniline, m-methylaniline, 2,3-dimethylaniline, 2,4-dimethylaniline, 2,5-dimethylaniline, 2,6-dimethylaniline, 3,5-dimethylaniline, fluorobenzene, etc.

Particularly useful substituted benzenes are those having two or more substituents where one substituent is a methyl group.

Accordingly, in a preferred embodiment, said substituted benzenes are selected from the group consisting of: benzoylchloride, benzoylbromide, 2,3-epoxypropyl-benzene, benzaldehyde, thiophenol, phenol, aniline, and methyl-substituted compounds thereof.

It is also believed that particularly useful substituted benzenes are those which do not include oxygen atoms. This is particularly true when the substrate is silicon-containing in that any formation of Si—O—C bonds (which may be susceptible to hydrolysis with strong bases) between the oxygen atom of the substituted benzene and silicon atoms of the substrate is thereby avoided. Preferably less than 5 mol-% of the monomers of the substituted benzene type comprises oxygen atoms.

As will be obvious from the above, the monomer gas may comprise other monomer types than the substituted benzene monomers.

In order to fully benefit from the advantageous properties provided with the substituted benzene monomers, it is believed that the content of substituted benzene monomers, should be at least 5 mol-%, although the content can be even higher such as in the range of 10-100 mol-%, e.g. 25-100 mol-%, such as 75-100 mol-%, and often about 100%.

The amount defined for the substituted benzenes may encompass one or two or more different substituted benzenes, normally however, only one is used or two are used together.

Other types of monomers can be used as the balance in the monomer gas in order to modify the properties of the materials. Such other types of monomer may be provided either by preparing a mixture of monomers to be applied simultaneous or by providing alternating amounts of different monomer types so as to form a virtual mixture in the plasma environment.

Illustrative examples of other monomer types to be selected from vinyl, propen-1-yl, 5 propen-2-yl, acetylene, vinylacetate, vinylpyrolidone, ethyleneglycolvinylether, diethyleneglycolvinylether, methyl acrylate, methylmethacrylate, allylalcohol, perfluorohexene, perfluoromethyl-pentene, hexene, pentene, propene, ethylene, cyclohexene, acetylene, styrene, vinylbornene, acid anhydrides (in particular carboxylic acid anhydrides), acid halides (in particular carboxylic acid halides) such as acid chlorides, acid bromides, acid fluorides, acid iodides, epoxides, aldehydes, carboxylic acids, and thiols. In addition to the monomers above, the monomer gas may also comprise gaseous monomers such as NH₃, N₂, N₂O, CO₂, etc.

Further examples of other gaseous monomers are H₂, O₂, H₂O, and COCl₂.

As mentioned above, it has been found that the double bonds originating from the benzene structure often are virtually absent in the polymeric material. This being said, the materials will generally have less than 20% of the double bonds originating from the benzene structure of the substituted benzenes left. Typically as little as less than 10% of the double bond, preferably less than 5%, of the double bonds originating from the benzene structure of the substituted benzenes are left. This appears to be an important characteristic of the materials of the present invention.

The amount of double bonds left can be determined by FT-IR measurement or by reaction with bromine or fluoro-compounds followed by elemental analysis with EPS (X-ray Photoelektron Spectroscopy).

The plasma type advantageously used in the concept of the present invention is one generated by a multiple phase AC supply or a DC supply. It has been found that this type of plasma has a level of intensity, or as defined herein a plasma power density (see detailed description), which allows a substantial portion of the functional groups to be preserved.

It is particularly advantageous to utilise a two or three phase AC plasma which offers the possibility of using a sufficiently low energy, e.g. a plasma power density (energy levels) of at the most 15 W/l such as at the most 10 W/l. Preferably, the a plasma power density (intensity of the plasma) is in the range of 10 mW/l to 15 W/l, such as 10 mW/l to 10 W/l, e.g. 10 mW/l to 5 W/l.

Other types of generators of the plasma may also be applicable, e.g. RF and MF plasma and pulsed variants thereof.

The pressure in the reaction chamber will normally be in the range of 10-1000 μbar, such as 25-500 μbar. The pressure in the reaction chamber is controlled by a vacuum pump, and a supply of an inert gas and the monomer gas. The inert gas is suitably a noble gas such as helium, argon, neon, krypton or a mixture thereof.

Hence, a plasma reaction chamber can be adapted in accordance with the instructions given herein with possible modification obvious for the person skilled in the art.

The plasma polymerisation process is normally conducted for a period of 10-1000 s, such as 20-500 s.

The plasma polymerised material can be provided on a substrate in a substantially uniform thickness if desired. It is believed that the layer thickness of the material generally is in the range of 5-5000 nm, such as in the range of 10-1000 nm, typically 10-200 nm.

This being said, the present invention also relates to a polymeric material obtainable by the plasma polymerisation method defined herein.

A wide range of substrates are suitable in the method of the invention, thus typically the solid substrate essentially consists of a material selected from polymers, e.g. polyolefins such as polyethylene (PE) and polypropylene (PP), polystyrene (PS), or other thermoplastics such as polytetrafluoroethylene (PTFE), tetra-fluoroethylene-hexafluoropropylencopolymers (FEP), polyvinyldifluoride (PVDF), polyamides (e.g. nylon-6.6 and nylon-11), and polyvinylchloride (PVC), rubbers e.g. silicon rubbers, glass, silicon, paper, carbon fibres, ceramics, metals, etc. Presently preferred materials are silicon, polyethylene (PE), polystyrene (PS) and glass, of which silicon is particularly interesting in view of the particularly useful products for micro-structuring lift-off techniques.

The substrate material may be pre-coated or pre-treated in order to modify the properties 30 thereof, e.g. the ability of the surface to adhere to the plasma polymerised material or the hydrophobic or hydrophilic properties of the substrate as such. The pre-coating may (also) be performed by plasma polymerisation. In the case of silicon, it is preferred that the surface therefor is pre-treated with a hydrogen plasma before the material is provided onto the silicon in that occasional Si—OH groups are thereby converted to Si—H groups.

This step can be performed as a pre-step to the steps of the method of the invention (see e.g. Example 1). Also, pre-treatments with argon so as to clean and possibly to activate the surface prior to plasma polymerisation with the substituted benzene is interesting.

Thus, the present invention also provides a substrate coated with a layer of a polymeric material according to the invention.

As it is illustrated in the examples, a further plasma polymerised layer may be provided on top of the material defined above. Such a layer may provide special surface properties to the material, e.g. hydrophobicity, hydrophilicity, etc.

The present invention furthermore provides a method for preparing a substrate coated with a layer of a cross-linked plasma polymerised material, the method comprising treatment of the substrate with a monomer gas in a plasma in order to provide the layer of the plasma polymerised material onto the surface, said monomer gas comprising one or more monomers selected from substituted benzenes.

The present invention is particularly useful for providing tough cross-linked materials for micro-structuring, in particularly micro-structuring processes where the lift-off technique is utilised. The lift-off technique requires that the materials used can resist treatment with strong solvents such as acetone, toluene, dichloroethylene, THF, NaOH solutions at pH 14, etc.

As illustrated in the non-limiting examples, the materials of the present invention fulfil the requirements of micro-structuring techniques. This being said, the materials can be used for numerous other purposes.

Other uses include use of a polymeric material according to the invention as a diffusion barrier, preferably such use wherein said polymeric material has less than 30% of the double bonds originating from said substituted benzenes are left in the material.

Further uses include use of a polymeric material or a coated substrate according to the invention as a substrate for immobilizing chemical substances, preferably such use wherein said polymeric material has more than 1% of substituent groups preserved.

In particular such use wherein said substance is selected from the group consisting of oligo RNA, oligo DNA, oligo PNA, proteins, peptides, hormones, blood components, antigens and antibodies.

### BRIEF DESCRIPTION OF THE DRAWING

In the following, by way of examples only, the invention is further disclosed with detailed description of preferred embodiments. Reference is made to the drawing in which

FIG. 1 shows FT-IR spectra for para-xylene monomers (lower curve) and for plasma polymerised para-xylene (upper curve).

### DETAILED DESCRIPTION

“Apparatus for Plasma Polymerisation of Substituted Benzenes”

Reference is made to plasma polymerisation apparatus as disclosed in EP 0 741 404 B1 and WO 00/44207, hereby incorporated by reference.

In a preferred embodiment plasma polymerisation of substituted benzenes is carried out in an apparatus comprising: a cylindrical vacuum chamber of height 30 cm and diameter 40 cm equipped with a set of concentric cylindrical electrodes of length 20 cm, the inner electrode of diameter 28 cm circumferenced by the outer electrode of diameter 30 cm. The inner electrode is made from a stainless steel grid of thickness 1 mm, and the outer electrode is made from a 0.5 mm thick stainless steel plate. The electrodes are connected in series with a 150 W incandescent lamp to the output from a 50 Hz alternating current (AC) power supply comprising a variable transformator connected on the constant voltage side (230 V) to the standardised European 50 Hz 230 V power grid and on the variable side (0-230 V) to the low voltage side of a (2:5) step-up transformator, the high voltage side of said step-up transformator being the power supply output. The role of the lamp is twofold; it serves as electrical fuse and it dampens eventual formation of electrical sparks in the plasma.

With this set-up a low frequency alternating current (AC) direct plasma is formed between the inner and the outer electrode, which plasma diffuses into the cylindrical volume encompassed by the inner electrode. It is this diffusion plasma which is used for the plasma polymerisation described in Example 5.

“Plasma Power Density”

The voltage, U, and current, I, is measured over the electrodes and logged in a PC at a sample rate of 4000 per s. The electrical power, Pₑₗ, consumed in the plasma was accurately computed by integrating the product of corresponding voltage and current values over time.

$${P}_{el} = {\int }_{to}^{to + Δ t} ( U \times I ) ⅆ t / Δ t \qquad ( 1 )$$

where Δt is the total plasma on-time. The plasma power density, ρel, is given by the plasma power divided by the volume of the outer electrode, V, which outer electrodes can be assumed to encompass the plasma,

ρₑₗ=Pₑₗ/V (2)

“Adjustment of Plasma Power Density”

Tuning the variable transformator controlled the power. The vacuum is supplied by a rotary vane vacuum pump, type 2021 Serial No. 248898 supplied by Alcatel, connected to the vacuum chamber by a flexible steel pipe. Argon is fed to the chamber from a pressurised flask, and the argon flow rate is controlled by a 50 standard cubic centimetre per minute (sccm) flow controller. The monomer feed gas is led to the chamber from a 100-ml glass flask through a manually tuneable reduction valve connected in series with a ball valve. Tuning the reduction valve controls the monomer flow rate.

Varying the pressure can also control the plasma power density.

The pressure in the chamber is controlled by varying the monomer flow rate and monitored with a pressure gauge connected to a digital display. Optionally the argon gas can be bobbled through the monomer before entering the vacuum chamber. Bobbling argon through the monomer increases the partial pressure of the monomer, and is used for monomers of very low vapour pressure. In this case varying the argon flow rate controls the pressure.

“Experimental Conditions for Plasma Polymerisation”

Plasma polymerisations are carried out at a suitable pressure typically in the range of 0.01 mbar to 1 mbar, e.g. a pressure of 0.15 mbar, with a suitable gas flow typically in the range of 1 sccm to 100 sccm, e.g. an argon flow at a rate of 10 sccm, and for a suitable time typically in the range of 1 s to 10 min, e.g. a duration time of 10 minutes.

“Analysis of Plasma Polymerised Deposit Layer”

Rectangular NaCl crystals are used as substrates, and the chemical structure of the plasma polymerised coatings are analysed by carrying out FT-IR analysis on the crystals before and after plasma treatment and subtracting the two spectra. Likewise the monomers are analysed by FT-IR.

“Extent of Aromatic Carbon-Carbon Double Bonds Conversion and Extent of Substituent Group Conversion”

By comparing the spectra of the monomer and that of the polymerised layer it can be estimated to which extent the aromatic carbon-carbon double bonds have been converted in the plasma polymerisation process. The degree of conversion of the aromatic double bonds is quantified on the basis of the measured absorbance spectrum a (λ), λ being the wave number in cm⁻¹, in the following way:

First baselines are constructed in the respective spectra of the monomer, M, and of the coating, C. Next, the monomer spectrum is normalised such that the maximum absorbance in the wave number interval 2900-2950 cm⁻¹ is the same for the two spectra. The total absorbance due to aromatic double bonds, A_{Ar}, is then computed by integrating the difference between the baseline and the absorbance of the aromatic peak near 1500 cm⁻¹ for the monomer as well as for the coating.

$${A}_{Ar , i} = {\int }_{1500 - {λ}_{o}}^{1500 + {λ}_{o}} ( {A}_{baseline} - A ( λ ) ) ⅆ λ , i = M , C \qquad ( 3 )$$

where λ₀ depends on the exact position and shape of the the absorbance peak near 1500 cm⁻¹ and is estimated for each spectrum. Finally, the degree of conversion of aromatic double bonds, ΔA_{Ar}, was calculated from FT-IR data in the following way:

ΔA_{Ar}=(A_{Ar,M}−A_{Ar,C})/ A_{Ar,M} (4)

In some cases the aromatic peak near 1500 cm⁻¹ can not be used for the quantification because of interfering peaks near 1500 cm⁻¹.

In such cases the aromatic absorption peak near 1600 cm⁻¹ or the aromatic peaks near 3000 cm⁻¹ are used instead.

In yet other cases it is simply not possible to quantify ΔA_{Ar}. This is illustrated by a dash in table I (see Example 5), listing values of ΔA_{Ar} for a number of substituted benzenes. Also, in the table there is given the degree of conversion of the substitution group, ΔA_{Sub}, calculated in the same way as ΔA_{Ar} but on the basis of the absorbance peak at a specific wavenumber, λ_{sub}, of the respective substitution group. ΔA_{sub} is calculated for hydroxyl, aldehylde, and amine only.

### EXAMPLES

Preferred embodiments of the invention are further illustrated by the following examples.

### Example 1

### “Hydrophobic Coating on Silicon Wafer”

4″ silicon wafers on which SiO₂ was grown (1000 Å) were placed in a 135 litre 2-phase AC-plasma chamber. The pressure in the chamber was lowered to 0.05 mbar and a flow of 20 sccm argon was led into the chamber. A plasma of 5 W/l was started. After 60 seconds the flow of argon was lowered to 10 sccm and a flow of hydrogen (10 sccm) was started. After another 30 s the argon flow was stopped. After 60 seconds with hydrogen plasma, the hydrogen flow was stopped, a flow of p-xylene vapour (20 sccm) and a flow of argon (10 sccm) was started. The power was lowered to 3 W/l. After 60 s with plasma polymerisation of p-xylene, the p-xylene flow was stopped. The plasma was turned off, all flows were stopped and the pressure was raised to atmospheric pressure.

The surface is first treated with argon so as to clean and possibly activate the surface.

Hydrogen is then provided with the aim of reducing any Si—OH groups on the surface to Si—H groups so that the subsequently added p-xylene were able to form Si—C—R bonds with the silicon substrate. Without the reduction with hydrogen, it is believed that base labile Si—O—C—R groups could have been formed.

### Example 2

### “Hydrophilic Coating on Silicon Wafer”

The procedure from Example 1 was repeated with the exception that a flow of 1-vinyl-2-pyrolidone (15 sccm) was started after the xylene flow was stopped. The power was lowered to 0.5 W/litre and the pressure was raised to 0.1 mbar. The plasma polymerisation of 1-vinyl-2-pyrolidone was continued for 120 s. The plasma was turned off, all flows were stopped and the pressure was raised to atmospheric pressure.

The final layer of poly(vinyl pyrolidone) provides a hydrophilic functionality. It is envisaged that any other functionality may be provided on top of the plasma polymerised substituted benzene layer.

### Example 3

### “Solubility Tests”

Test coating of plasma polymerised p-xylene on glass (otherwise as in Example 1) were refluxed in acetone and toluene, respectively, for 24 hours. The contact angle with water was subsequently measured in order to determine whether the coating was left on the substrate. All samples showed a contact angle of between 550 and 950 (water on glass would give a contact angle of approx. 400). The measured contact angle was substantially equal to the contact angle measured before the refluxing.

Similar samples were tested in basic environment in solutions of NaOH. The coatings resisted a solution with pH 12.5 for more than 24 hours and a solution with pH 14 for more than 1 hour.

It was therefore concluded that the coating layers were able to resist even harsh 15 conditions.

### Example 4

### “IR Measurements”

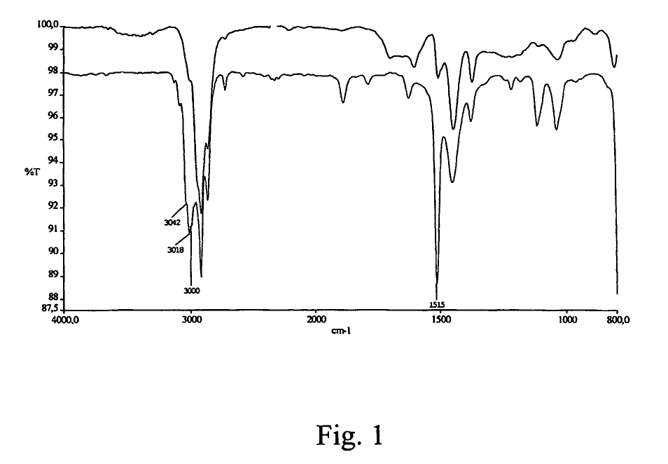

The FTIR curves shown in FIG. 1 (upper curve: plasma polymerised p-xylene; lower 20 curve: p-xylene monomer) illustrates the conversion of aromatic double bonds to single bonds. The marked peaks (1515, 3000, 3018, 3042 cm⁻¹) are all indications of double bonds in the aromatic structure. Not only is it clear that the double bonds have disappeared, but it also appears that the amount (number) of double bonds is dramatically reduced (below 10%) in plasma polymerised p-xylene compared with p-xylene.

### Example 5

### “Plasma Polymerisation of Substituted Benzenes Effect of Plasma Power Density”

A plasma polymerisation apparatus as described in the detailed description was used for providing diffusion plasma for plasma polymerisation examples (see Table I) described in the present example.

All plasma polymerisations were carried out at pressure 0.15 mbar, argon flow rate 10 sccm, and duration 10 minutes. In order to investigate the effect of the electrical power on the structure of the resulting plasma polymerised layers all monomers were plasma polymerised twice; at 0.1 W/l and at 1 W/l, respectively.

Results are shown in Table I. Also given in the table is the conversion of the substitution group, ΔA_{sub}, calculated in the same way as ΔA_{Ar} but on the basis of the absorbance peak at a specific wavenumber, λ_{sub}, of the respective substitution group. ΔA_{sub} is calculated for hydroxyl, aldehylde, and amine only.

It can be seen from Table I that surprisingly high conversions of the aromatic double bonds has been achieved even at the low power input of only 0.1 W/l. Thus, conversion of aromatic double bonds is generally higher at higher power density, e.g. 1 W/l, than at lower power density, e.g. 0.1 W/l, as one would expect.

TABLE I

| | | |
|---|---|---|
| monomer | ΔA_{Ar}(%) | ΔA_{sub}(%) |

| substituent(s) | ρₑₗ(W/l): | 0.1 | 1 | 0.1 | 1 |
|---|---|---|---|---|---|
| methyl | toluen | 67 | 73 | | |
| 2 × methyl | o-xylene | 63 | 81 | | |
| do | m-xylene | 60 | 70 | | |
| 3 × methyl | 1,3,5-tri-methyl- | 59 | 71 | | |
| | benzene | | | | |
| methyl, hydroxyl | m-cresol | 79 | 80 | 70 | 75 |
| methyl, aldehyde | m-tolualdehyd | 80 | — | 94 | 100 |
| do | p-tolualdehyd | 80 | — | 95 | 100 |
| methyl, amine | m-toluidin | 26 | — | 56 | 19 |
| amine | aniline | 44 | 56 | 67 | 63 |
| amine, tri- | 3-tri-fluoro- | 38 | 82 | 44 | <0^{*)} |
| fluoromethyl | methylaniline | | | | |
| fluor | fluorobenzene | 58 | 70 | | |
| 2 × fluor | 1,4-di- | 52 | 64 | | |
| | fluorobenzene | | | | |
| 3 × fluor | 1,3,5-di- | 82 | 79 | | |
| | fluorobenzene | | | | |
| methyl, fluor | m-fluorotoluene | 64 | 85 | | |

^{*)}ΔA_{sub} < 0 implies that the relative content of amine in the coating is higher than in the monomer.

Likewise the conversion of substituents hydroxyl and aldehyde is higher at the high power density. In fact all the aldehyde is lost in the plasma process at the high power density. For the amine the reverse is observed, i.e., at high power the relative content of amine is higher at the high power density. In the case of 3-tri-fluoromethylaniline the relative content of amine in the coating is even higher than in the feed monomer.

What can not be seen in Table I is the fact that the destinct amine absorptions peaks in the spectra of the amine substituted benzenes to a large degree are maintained in the spectra of the respective coatings polymerised at 0.1 W/l, whereas the peaks have been smeared out in the spectra of the coatings polymerised at 1 W/l.

This is partly due to the fact that some of the aromatic amine of the monomer has been converted to aliphatic amine during the polymerisation to the extent that the aromatic double bonds adjacent to the amine substituent have been converted. A further reason for the broadening of the amine peaks is that more rearrangement of the chemical groups occurs at higher plasma power. This implies that in cases where the exact functionality of the substituent should be maintained low plasma power density should be employed.

In conclusion polymer coatings have been successfully produced by plasma polymerisation of substituted benzenes. The conversion of aromatic double bonds has been found to increase with increasing plasma power, as one would expect. However, even at a very low plasma power density, such as 0.1 W/l, aromatic conversion in the range from 25% to 80% was obtained by the method described in the present example.

Likewise, the conversion of substituent groups hydroxyl and aldehydes were observed to increase with increasing plasma power, whereas the conversion of amine substituents was observed to decrease with increasing plasma power density.

On the basis of these results the cross-link density and the substituent density of plasma polymerised coatings can be controlled by accurately controlling the plasma power density in the range from below 0.1 W/1 up to 15 W/l.

### Example 6

### “Plasma Polymerisation of Styrene”

A rectangular NaCl crystal was placed in an alternating current diffusion plasma apparatus similar to the plasma apparatus used in Example 5. A polymer coating was deposited on the crystal by plasma polymerisation of styrene in the presence of argon at a pressure of 0.075 mbar, an argon flow of 40 sccm, a plasma power density of 2 W/l for 120 s at an AC frequency of 50 Hz.

The coating was analysed by FT-IR and the resulting spectrum was compared with that of pure styrene. In the spectrum of styrene intense absorption bands are observed in the range 3000-3100 cm⁻¹ due to the C—H bonds of the aromatic and vinylic structures. In the range 2800-3000 cm⁻¹ virtually no IR-absorption is observed indicating the lack of aliphatic C—H bonds. In the spectrum of the coating only moderate absorption peaks were observed in the range 3000-3100 cm⁻¹, whereas major absorption peaks were observed in the range 2800-3000 cm⁻¹, i.e. a substantial amount of the vinylic and aromatic double bonds had been converted to aliphatic bonds. On the basis of the absorption spectra in the respective ranges 2800-3000 cm⁻¹ and 3000-3100 cm⁻¹ of the monomer and of the coating the total conversion of double bonds was quantified, and it was found that about 70% of the total amount of double bonds had been converted. It is not clear from the spectra to which extend the vinylic double bonds had been converted. However, assuming a 100% conversion of the vinylic double bond, the conversion of the vinylic double bond accounts for about 25% of the total conversion, and the remaining 45% conversion must be ascribed to the conversion of aromatic double bonds.

In conclusion at least 45% of the aromatic double bonds of styrene were converted in the plasma polymerisation process.

1. A method of plasma polymerisation of monomers for providing a cross-linked polymeric material, the method comprising: treating a monomer gas in a plasma, said monomer gas comprising one or more monomers selected from substituted benzenes, wherein said plasma is generated by a multiple phase AC supply or a DC supply at a plasma power density allowing a substantial portion of substituent groups of said substituted benzenes to be preserved.

2. The method according to claim 1 wherein said substituted benzenes have the general formula:
Ar(Rⁿ)ₙ
wherein Ar is a benzene ring, n is 1-6 and Rⁿ is n substituents (R¹, R², R³, R⁴, R⁵, R⁶) covalently bound to the benzene ring, the substituents (R¹, R², R³, R⁴, R⁵, R⁶) being independently selected from C₁₋₆-alkyl, C₁₋₆-alkoxy, C₁₋₆-alkylcarbonyl, C₁₋₆-alkylcarbonyl, C₁₋₆-alkoxycarbonyl, carbamoyl, mono- and di(C₁₋₆-alkyl)aminocarbonyl, formyl, hydroxy, carboxy, carbamido, thiolo, nitro, cyano, nitro, amino, mono- and di(C₁₋₆-alkyl)amino, and halogen (fluoro, chloro, iodo, bromo), wherein the C₁₋₆-alkyl and C₁₋₆-alkoxy groups in the above may be substituted with substituents, preferably 1-3 substituents, selected from hydroxy, C₁₋₆-alkoxy, carboxy, amino, mono- and di(C₁₋₆-alkyl)amino and halogen.

2. The method according to claim 1 wherein said substituted benzenes are selected from the group consisting of: benzoylchloride, benzoylbromide, 2,3-epoxypropyl-benzene, benzaldehyde, thiophenol, phenol, aniline, and methyl-substituted compounds thereof.

3. A method according to any one of claim 1 or 2 wherein less than 40%, preferably less than 30%, in particular less than 10% of the double bonds originating from said substituted benzenes are left in the material.

4. A method according to any one of claims 1-3 wherein more than 1%, preferably more than 10%, in particular more than 20% of said substituent groups are preserved.

5. A method according to any one of claims 1-4 wherein the monomer or monomers of the general formula constitutes at least 5% of the monomer gas.

6. A method according to any one of claims 1-5 wherein a said multiple phase AC supply is a two phase AC, or a three phase AC supply.

7. A method according to any one of claims 1-4 wherein said plasma power density of the plasma is at the most 15 W/l, preferably at the most 10 W/l.

8. A method according to any one of claims 1-4 wherein said plasma power density of the plasma is in the range of 10 mW/l to 15 W/l, preferably 10 mW/l to 10 W/l, in particular 10 mW/l to 5 W/l.

9. A polymeric material obtainable by the plasma polymerisation method defined in any one of claims 1-8.

10. A coated substrate, the substrate being coated with a layer of a polymeric material as defined in any one of the claims 1-9.

11. A coated substrate according to claim 10 wherein said layer of said polymeric material is coated in said treatment in said plasma.

12. Use of a polymeric material as defined in claim 9 or 10 as a diffusion barrier, said polymeric material having less than 30% of the double bonds originating from said substituted benzenes are left in the material.

13. Use of a polymeric material or a coated substrate as defined in any one of claims 9-12 as a substrate for immobilizing chemical substances.

14. Use of a polymeric material or a coated substrate according to claim 13 wherein said polymeric material has more than 1% of substituent groups preserved.

15. Use of a polymeric material or a coated substrate according to claim 13 or 14 wherein said substance is selected from the group consisting of oligo RNA, oligo DNA, oligo PNA, proteins, peptides, hormones, blood components, antigens and antibodies.
